(19) United States
(12) Patent Application Publication
(10) Pub. No.: US 2014/0315528 A1
(43) Pub. Date: Oct. 23, 2014

(54) EMISSION REPORTING AND MONITORING

(71) Applicant: ALCATEL LUCENT, Paris (FR)

(72) Inventor: Varun Gupta, Gurgaon (IN)

(73) Assignee: ALCATEL LUCENT, Paris (FR)

(21) Appl. No.: 14/351,668

(22) PCT Filed: Sep. 21, 2012
(86) PCT No.: PCT/EP2012/068586

§ 371 Date: Apr. 14, 2014

(30) Foreign Application Priority Data
Oct. 10, 2011 (IN) 2915/DEL/2011

(51) Int. Cl. H04W 4/04

(52) U.S. Cl. CPC H04W 4/04; H04W 4/005
USPC 455/414.2

(57) ABSTRACT

Described are embodiments of methods, an emission data encoding and transmission system (102) to encoded emission data and identification data associated with at least one emission generating entity (EGE) (106) and transmit the encoded data via a telecommunication network entity to an emission data collection and monitoring system (104), where the encoded data is processed to obtain the emission data and the identification data. According to one embodiment, the method comprises obtaining the emission data and the identification data associated with the at least one EGE (106), generating an encoded message comprising, at least in part, the emission data and the identification data, and transmitting the encoded message to a telecommunication network entity. In one embodiment, the method comprises receiving the encoded message from a telecommunication network entity, processing the encoded message to obtain the emission data and the identification data, and using the obtained data for various purposes.

### FIELD OF INVENTION

The present subject matter relates to systems and methods for reporting and monitoring of emissions and, particularly but not exclusively, to reporting and monitoring of harmful automobile and industrial emissions via a telecommunication network.

### BACKGROUND

A majority of environmental pollution is caused by the release of harmful substances in air, water and soil. The harmful substances that are released in the environment include suspended particulate matter (SPM), harmful gases, such as carbon dioxide (CO₂), carbon monoxide (CO), nitrogen oxides (NOx) and sulfur oxides (SOx), non-biodegradable and toxic wastes, such as toxic metals and radioactive wastes, etc. Motor vehicles, including cars, motorcycles, buses, trucks, airplanes, ships, etc., manufacturing industries, and power generation plants, which emit harmful gases in air and release toxic and non-biodegradable wastes in water and soil are the major contributors to environmental pollution. Environmental pollution, due to emission of harmful gases in air, has led to various environmental and health hazards in addition to global warming and thus, is a cause of concern world over.

Typically, there are pollution controlling policies imposed by governments of most of the countries. These pollution controlling policies impose standardized pollution norms on pollution emitting motor vehicles and industries. Motor vehicles and industries are bound to adhere to such pollution controlling policies and are required to control amounts of harmful gases and other toxic wastes released by them in air, water and soil. In case, motor vehicles and/or industries are found not to comply with the standardized pollution norms, a suitable penalty, for example a monetary charge, may be imposed on them.

### SUMMARY

This summary is provided to introduce concepts related to reporting and monitoring of emissions via a telecommunication network. This summary is not intended to identify essential features of the claimed subject matter nor is it intended for use in determining or limiting the scope of the claimed subject matter.

In accordance with an embodiment of the present subject matter, an emission data encoding and transmission system, configured to encode emission data associated with an emission generating entity (EGE) and transmit the encoded data via a telecommunication network entity, is described. The emission data encoding and transmission system is configured to obtain emission data associated with at least one EGE. The emission data encoding and transmission system is also configured to generate an encoded message including, at least in part, the emission data, and transmit the encoded message to a telecommunication network entity. In one embodiment, the encoded message is a Global System for Mobile Communication based Location Update (GLU) message. Further, in one embodiment, the emission data encoding and transmission system is configured to obtain identification data associated with the at least one EGE, and the encoded message includes, at least in part, the identification data.

In accordance with another embodiment of the present subject matter, emission data collection and monitoring system is described. The emission data collection and monitoring system is configured to receive an encoded message from a telecommunication network entity. The encoded message includes, at least in part, emission data and identification data associated with at least one EGE. The emission data collection and monitoring system is also configured to process the encoded message to obtain the emission data and the identification data. In one embodiment, the encoded message is a GLU message. Further, in one embodiment, the emission data collection and monitoring system is configured to compute a severity level of emissions for the at least one EGE by comparing the emission data with predefined emission limits. Further, in one embodiment, the emission data collection and monitoring system is configured to communicate with one or more of a notification system, a financial system, a statistics and report generating system, a carbon credit computing system, and a vehicle tracking system.

In accordance with another embodiment of the present subject matter, a method includes obtaining emission data and identification data associated with at least one EGE, generating an encoded message including, at least in part, the emission data and the identification data, and further transmitting the encoded message to a telecommunication network entity. In one embodiment, the encoded message is a GLU message, and Location Updating Type in the GLU message is configured. Further, in one embodiment, Location Area Identification is configured with the emission data and Mobile Identity is configured with the identification data.

In accordance with another embodiment of the present subject matter, a method includes receiving a GLU message from a telecommunication network entity. The GLU message includes, at least in part, emission data and identification data associated with at least one EGE. The method further includes processing the GLU message to obtain the emission data and the identification data associated with the at least one EGE.

In accordance with another embodiment of the present subject matter, a computer readable medium having a set of computer readable instructions is disclosed. The computer readable instructions on the computer readable medium, when executed, perform acts including obtaining emission data associated with at least one EGE, obtaining identification data associated with the at least one EGE 106, generating a GLU message including, at least in part, the emission data and the identification data, and transmitting the GLU message to a telecommunication network entity.

In accordance with yet another embodiment of the present subject matter, a computer readable medium having a set of computer readable instructions is disclosed. The computer readable instructions on the computer readable medium, when executed, perform acts including receiving a GLU message from a telecommunication network entity. The GLU message includes, at least in part, emission data and identification data associated with at least one EGE 106. The acts may also include processing the GLU message to obtain the emission data and the identification data associated with the at least one EGE 106, and communicate the emission data and the identification data for at least one predefined process.

### BRIEF DESCRIPTION OF THE FIGURES

The detailed description is described with reference to the accompanying figures. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 schematically illustrates an emission reporting and monitoring system, in accordance with an embodiment of the present subject matter.

FIG. 2 illustrates an emission data encoding and transmission (EDET) system and an emission data collection and monitoring (EDCM) system, in accordance with an embodiment of the present subject matter.

FIG. 3 illustrates a call flow diagram for communication between the EDET system and the EDCM system in a GSM network, in accordance with an embodiment of the present subject matter.

FIG. 4 illustrates a message flow diagram for communication between the EDCM system and a financial system, in accordance with an embodiment of the present subject matter.

FIG. 5 illustrates a method for encoding and transmitting of emission data and emission generating entity (EGE) identification data associated with an EGE, in accordance with an embodiment of the present subject matter.

FIG. 6 illustrates a method for collecting and monitoring of emission data and EGE identification data associated with EGEs, in accordance with an embodiment of the present subject matter.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

### DETAILED DESCRIPTION

The present subject matter relates to systems and methods for reporting and monitoring emissions from Emission Generating Entities (EGEs) via a telecommunication network. EGEs, such as vehicles, manufacturing industries, power generation plants, release harmful substances in atmosphere to cause environmental pollution. Harmful substances released by such EGEs include effluents, suspended particulate matter (SPM), gases, such as carbon dioxide (CO₂), carbon monoxide (CO), nitrogen oxides (NOx), sulfur oxides (SOx), ammonia, etc. Typically, the EGEs are required to adhere to prescribed pollution norms imposed within their respective jurisdictions. Each jurisdiction may have their own pollution norms or may follow global pollution norms. Further, EGEs may be required to maintain carbon credits in accordance with the pollutants generated by them, as per the norms set by their respective jurisdictions.

Monitoring of levels of harmful substances emitted by the EGEs is important to keep a check on the environmental pollution, its impact on humanity and nature, and to facilitate a mechanism of trading of carbon credits among EGE owners. Typically, the monitoring of emissions, for example measuring, recording and compilation of emission data relating to the various EGEs is done manually and is done for each EGEs on an individual basis by government authorities, such as the pollution control authority. Such a government authority may issue warnings and/or impose fines on the EGEs in case the emission levels exceed the prescribed pollution norms.

Typically, for monitoring emissions from a mobile EGE, such as a vehicle, the vehicle is driven to a pollution checking station installed by the pollution control authority. At the station, emissions from the vehicle are measured and compared with prescribed emission limits based on the imposed pollution norms. For measuring the vehicular emissions, a sensing probe configured with a typical gas analyzer may be inserted in the exhaust pipe of the vehicle. The sensing probe measures amounts of SPM and various gases, such as CO, CO₂, NOx and SOx that are conventionally know as green house gases.

Based on the measurements and comparison with the prescribed emission limits, a vehicular emission report may be generated locally at the pollution checking station. If the report shows that the emissions from the vehicle exceed the prescribed emission limits, vehicle owner is asked to take measures to control the emission levels. For example, the vehicle owner may be asked to get the vehicle serviced and/or overhauled. Further, a suitable fine may be imposed on the vehicle owner for exceeding the prescribed emission limits, the vehicle may be stated as unfit for use, or may be impounded by the pollution control authority. On the other hand, if the report shows that the emissions from the vehicle are below the prescribed emission limits, a certificate of pollution under control is issued for the vehicle and declared fit for use.

Typically, for monitoring emissions from a static EGE, such as a factory and a power plant, a pollutant measuring sensor can be installed at the point of emissions. For example, the pollutant measuring sensor, such as a gas analyzer, is installed in chimneys from where the gases and other harmful substances are emitted. The pollutant measuring sensor measures the amounts of harmful substances, including effluents and gases emitted from the factory or the power plant. The measurement can be continuous or periodic. Typically, the pollution control authority individually monitors the emission values obtained from the pollutant measuring sensor installed at a static EGE. The emission values are compared with the prescribed emission limits, and based on the comparison the pollution controlling authority issues an emission report. In case it is evident from the report that the emissions from the static EGE exceed the prescribed emission limits, owner of the EGE is asked to take measures to control the emission levels. Further, as explained in context of the mobile EGE, a suitable fine may be imposed on the EGE owner for exceeding the prescribed emission limits. On the other hand, if the report shows that the emissions are below the prescribed emission limits, a certificate of pollution under control is issued for the EGE and may be declared as a clean EGE.

Reporting and monitoring of emissions from EGEs on large scale, for example nation-wide monitoring and reporting, through conventional systems and methods require a large infrastructure and involve a large amount of manual effort. Further, conventional systems and methods might be time consuming with limited coverage and limited access to remote areas and numerous Small and Medium Enterprises (SMEs), inefficient, costly, prone to human errors, and there are possibilities of forging the emission values in the emission reports and falsify data relating to the carbon credits.

Systems and methods for reporting and monitoring of emissions from EGEs are described herein. As described earlier, the emissions include harmful substances, such as green house gases, effluents and toxic wastes, which are released by the EGEs to pollute the environment. The systems and the methods of the present subject matter utilize a telecommunication network to communicate emission data associated with the EGEs. The systems and methods described herein enable efficient and real-time reporting and monitoring of emissions from the EGEs, such that the emission controlling policies can be uniformly implemented and regularized at a large scale to control environmental pollution.

In accordance with an implementation of the present subject matter, an Emission Reporting and Monitoring (ERM) system comprises one or more Emission Data Encoding and Transmission (EDET) systems and at least one Emission Data Collection and Monitoring (EDCM) system. The EDET system is configured to encode at least the emission data associated with an EGE in a format that can be transmitted to a telecommunication network entity. The emission data may be understood as data comprising details of pollutants emitted by the EGE. The EDCM system is configured to receive the encoded data from the telecommunication network entity and process the encoded data to decode the emission data associated with an EGE. The EDCM system may collect emission data associated with a plurality of EGEs and monitor, at a large scale, the emissions generated by the EGEs.

One or more of the systems and methods described herein can be implemented in a variety of entities, such as communication devices, and computing systems or devices. The entities that can implement the described method(s) include, but are not limited to, desktop computers, handheld devices, laptops or other portable computers, tablet computers, mobile phones, PDAs, smart phones, and the like. Further, one or more methods described herein may also be implemented by devices capable of exchanging data to provide connectivity to different communicating devices and computing systems. Such devices may include, but are not limited to, data cards, mobile adapters, wireless adapters, routers, and the like. Although the description herein is explained with reference to a communication device such as a handheld communication device, the described system(s) and method(s) may also be implemented in any other devices, as will be understood by those skilled in the art.

The systems and methods described herein can be implemented in a variety of telecommunication network employing various communication devices and/or computing system or devices. Also, the systems and methods can be implemented in any of the communication networks, such as Global System for Mobile Communication (GSM) network, Universal Mobile Telecommunications System (UMTS) network, Long Term Evolution (LTE) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Although the description herein is with reference to certain networks, the systems and methods may be implemented in other networks and devices, albeit with a few variations, as will be understood by a person skilled in the art.

In an implementation, the EDET system obtains identification data associated with the EGE along with its emission data. The identification data is indicative of the unique identity of the EGE. The identification data associated with an EGE hereinafter may be referred to as EGE identification data. The EDET system encodes the obtained emission data and the EGE identification data as an encoded message that may be communicated to a telecommunication network entity. In an implementation, the communication of the encoded message to the telecommunication network entity may be via a radio communication link. As will be appreciated by one skilled in the art, the encoded message may be in accordance with a telecommunication protocol. In one implementation, the EDET system may implement the GSM protocol using the standard GSM protocol messages for transmission of at least the emission data, and the telecommunication network entity may be a VMSC/VLR (Visited Mobile Switching Center/Visiting Location Register) of a GSM network.

In an implementation, the emission data from the EGE may include amounts of various green house gases and/or other harmful substances emitted by the EGE. For example, if the EGE is a vehicle, the emission data may specify the amounts of CO, CO₂, NOx, SOx and SPM emitted by the vehicle. In another example, if the EGE is a factory or an industry, the emission data may include the amounts of CO, CO₂, NOx, SOx, SPM, ammonia, toxic metals, non-biodegradable substances, effluents emitted by the factory or the industry.

In an implementation, the EGE identification data may include unique identity data that can be used to identify the type, class, sub-class and/or location of registration of the EGE. For example, EGE identification data may include a registration number of a vehicle or a factory, which is unique for each vehicle and factory.

In an implementation, the encoded message, which includes the emission data and the EGE identification data, upon being received by the telecommunication network entity, is provided to the EDCM system for decoding to obtain the emission data and the EGE identification data associated with the EGE. As mentioned earlier, in one example, the telecommunication network entity may be a VMSC/VLR of a GSM network. The obtained data provides the EDCM system the information relating to the EGEs generating emissions as well as the levels of various emissions generated by the respective EGE. This obtained emission data and the EGE identification data may then be used for various purposes. The purpose may include computing a severity level of emissions for the EGE 106 as identified from the EGE identification data. The severity level of emission may be computed by comparing the emission data with prescribed emission limits predefined for a particular type of EGE. The prescribed emission limits may indicate benchmark emission values for the EGE. In one implementation, based on the computation and comparison different actions may be taken. For example, the EGE may be notified of its emissions, the EGE may be penalized or fined in case the emissions are above the prescribed emission limits, the emission data may be used to generate global/national statistics and reports on emissions and/or the EGEs owners may be assigned carbon credits through a legal system based on their emission values. The systems and the methods of the present subject matter may also help in providing a comprehensive carbon trading platform for various EGE owners, and carrying out statistical research, data mining, emission trend analysis, which could be both holistic as well as EGE class based.

In accordance with an implementation, the EDET system and the EDCM system may operate based on the GSM standard. In said implementation, the EDET system is configured to encode and transmit the emission data and the EGE identification data in a form of a GSM-based Location Update (GLU) message. The GLU message may be understood to be a standard GSM protocol message used for the purpose of communication between telecommunication devices, such as mobile phones. The GLU message, according to the present subject matter, may be transmitted in the form of the standard telecommunication signal to the telecommunication network entity, such as a VMSC/VLR through BTS/BSC (Base Transceiver Station/Base Station Controller). The VMSC/VLR may further be configured to communicate the GLU message to the EDCM system. The EDCM system is configured to receive the GLU message, decode the emission data and the EGE identification data from the GLU message and subsequently use the decoded information for any of the above mentioned purposes.

Although the description provided herein is in context of emission emitted by EGEs such as motor vehicles, factories, and a power generation plant, it will be appreciated by one skilled in the art that the concepts explained in context thereto may be extend to other EGEs, such as EGEs that expel effluents in water bodies causing water and/or soil pollution.

The above methods and system are further described in conjunction with the figures below. It should be noted that the description and figures merely illustrate the principles of the present subject matter. It will thus be appreciated that those skilled in the art will be able to devise various arrangements that, although not explicitly described or shown herein, embody the principles of the present subject matter and are included within its spirit and scope. Furthermore, all examples recited herein are principally intended expressly to be only for pedagogical purposes to aid the reader in understanding the principles of the present subject matter and the concepts contributed by the inventor(s) to furthering the art, and are to be construed as being without limitation to such specifically recited examples and conditions. Moreover, all statements herein reciting principles, aspects, and embodiments of the present subject matter, as well as specific examples thereof, are intended to encompass equivalents thereof.

It will also be appreciated by those skilled in the art that the words during, while, and when as used herein are not exact terms that mean an action takes place instantly upon an initiating action but that there may be some small but reasonable delay, such as a propagation delay, between the initial action and the reaction that is initiated by the initial action. Additionally, the word “coupled” is used throughout for clarity of the description and can include either a direct coupling or an indirect coupling.

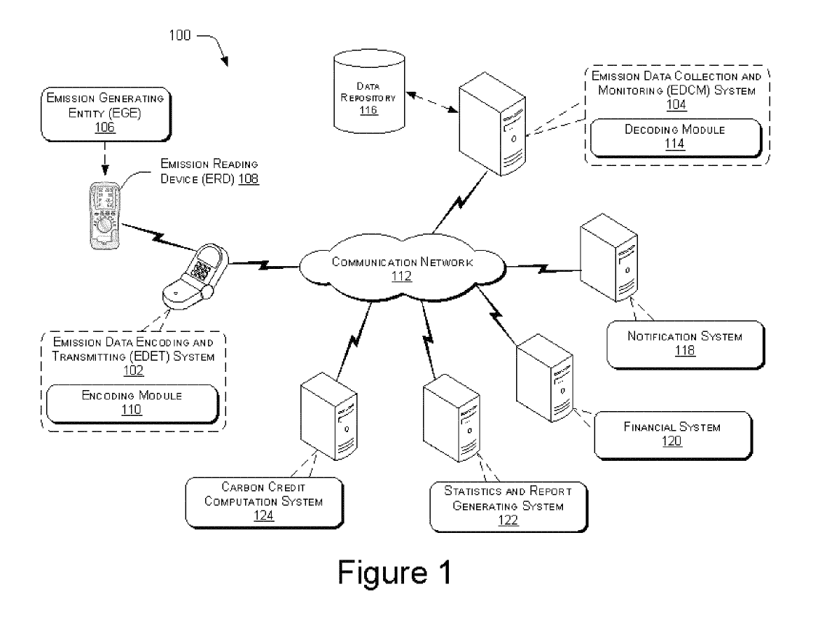

The manner in which the systems and methods for reporting and monitoring of emissions from EGEs via a telecommunication network is implemented shall be explained in details with respect to FIGS. 1-6. While aspects of described systems and methods for reporting and monitoring of emissions can be implemented in any number of different computing systems, environments, and/or configurations, the embodiments are described in the context of the following exemplary system(s).

FIG. 1 schematically illustrates an ERM system 100 implementing an EDET system 102 for encoding at least the emission data of an EGE 106, and an EDCM system 104 for processing the encoded data to obtain at least the emission data of the EGE 106, according to an embodiment of the present subject matter. The EDET system 102 depicted in FIG. 1 may be implemented in a variety of other communication devices that includes, but is not limited to, a handheld device, a PDA, a smart phone, and the like, or may be implemented as an individual entity. The EDCM system 104 may be implemented in a computing system that includes, but is not limited to, a desktop computer, a laptop, a mainframe computer, a server, and the like.

The EDET system 102 acquires the emission data associated with the EGE 106 from an emission reading device (ERD) 108. As mentioned earlier, the EGE 106 may be any EGE that generates emissions including harmful gases, effluents, toxic and non-biodegradable wastes, etc. The EGE 106 may include static EGEs, such as manufacturing industries, factories, energy producing plants; or mobile EGEs, such as road-based, air-based or sea-based motor vehicles. The ERD 108 may be a typical sensor capable of sensing harmful emissions and determine the amounts of such harmful emissions. For example, the ERD 108 may be a gas analyzer that can detect the various emitted gases and SPM emitted from the EGE 106 and determine the amounts of each gas and SPM. The ERD 108 may be coupled to the EGE 106 to detect the emissions from the EGE 106 in real-time or periodically.

In an implementation, the ERD 108 may be communicatively coupled to the EDET system 102 to communicate the emission data of the EGE 106 to which it is coupled. In this implementation, the ERD 108 may digitize the emission data, which may be communicated to the EDET system 102 using a wired communication link, such as a data cable, or via a wireless communication link, such as Bluetooth™, Infrared (IR) link, and WiFi. In another implementation, the emission data may be recorded by the ERD 108 and displayed on a display interface which may in turn be read from the ERD 108 and manually entered in the EDET system 102 through a user interface of the EDET system 102.

The EDET system 102 also obtains the EGE identification data associated with the EGE 106. In an implementation, the EGE identification data may be communicated to the EDET system 102 in a digital format from the ERD 108 coupled to the EGE 106 or any other source, or may be manually entered in the EDET system 102 through the user interface.

Upon acquiring the emission data and the EGE identification data associated with the EGE 106, an encoding module 110 of the EDET system 102 encodes the emission data and the EGE identification data in the form of a telecommunication-based encoded message. For the sake of simplicity, the telecommunication-based encoded message hereinafter may be referred to as the encoded message. After the encoding, the EDET system 102 communicates the encoded message, having the emission data and the EGE identification data, to the EDCM system 104 through a communication network 112.

The communication network 112 may be a wireless or a wired network, or a combination thereof. The communication network 112 can be a collection of individual networks, interconnected with each other and functioning as a single large network. Examples of such individual networks include, but are not limited to, GSM network, UMTS network, LTE network, PCS network, TDMA network, CDMA network, NGN, PSTN, and ISDN. Depending on the terminology, the communication network 112 includes various network entities, such as gateways and routers; however, such details have been omitted to maintain the brevity of the description. Further, the encoding of the emission data and the EGE identification data may depend on the communication protocol compatible with the communication network 112 over which the communication is taking place.

In an implementation, the communication network 112 includes a standard telecommunication network entity (not shown) that may include one or more of BSC, BTS, VMSC/VLR, Radio Network Controller (RNC), Node B, etc., depending on the type of communication network 112. The telecommunication network entity is configured to read the encoded message to determine whether the encoded message is a conventional telecom standard based signal or an encoded message comprising emission data and EGE identification data, received from the EDET system 102. In case the telecommunication network entity identifies the encoded message to be an EDCM based message comprising of emission data and EGE identification data, the encoded message is forwarded to the EDCM system 104. As apparent, the telecommunication network entity continues to deal with the conventional telecommunication standard based signal in a conventionally manner.

The EDCM system 104, upon receiving the encoded message from the telecommunication network entity over the communication network 112, processes the encoded message. The encoded message is processed by a decoding module 114 of the EDCM system 104 to obtain the emission data and the EGE identification data associated with the EGE 106.

In an implementation, the EDCM system 104 may receive more than one encoded message which may then be processed to obtain the emission data and the EGE identification data of the EGEs 106. The obtained data may be used for various predefined processes, a few of which are described in the description herein. For example, the severity levels of emissions from the EGEs 106 may be computed. In an implementation, the severity levels of emissions may be computed by comparing the amounts of various harmful substances emitted by the EGEs 106 with the corresponding prescribed emission limits. In an implementation, the severity computation and the comparison may be done locally at the EDCM system 104, whereas in the other the emission data and the EGE identification data of the EGEs 106 may be communicated by the EDCM system 104 to another entity for the purpose of severity computation and comparison.

In the implementation in which the severity computation and the comparison take place locally at the EDCM system 104, the EDCM system 104 communicates with a data repository 116 that stores, among other things, data related to prescribed emission limits. The emission data at the EDCM system 104 may be compared with the prescribed emission limits to compute the severity levels of emissions. Based on the severity level of emissions and/or the comparison further necessary actions may be taken. One example of such an action is sending notifications to owners of the EGEs 106.

In an alternate implementation in which the severity computation and the comparison do not occur locally at the EDCM system 104, the EDCM system 104 may communicate with a notification system 118, for example, through the communication network 112. In said implementation, the EDCM system 104 may be configured to transmit the emission data and the EGE identification data of the EGEs 106, obtained by processing the encoded message, to the notification system 118 and the notification system 118 may perform actions related to comparing the emission data, computing the severity level of emissions and sending notification to the owners of the EGEs 106. In said implementation, the notification system 118 may also be coupled to the data repository 116, for example, through the communication network 112 for the purposes of the above mentioned comparison to be performed by the notification system 118.

In an implementation, notifications may be communicated to the EGEs 106 and/or the owners of the EGEs 106 based on the comparison and/or the severity level of emissions. Such a notification may be communicated in a form of a SMS, email or any other known form of communication. The type and the content of the notification may be defined by the emission regulatory authorities, or any relevant authority, and may be update periodically or as needed.

In an implementation, based on the comparison of emission data, the EGE 106 or the EGE owners may be penalized. If the emissions from the EGE 106 are above the prescribed emission limits, a penalty may be imposed on the EGE owner based on the severity level of emissions from the EGE 106. In an implementation, the penalty on the EGE 106 may include monitory fines, temporary suspension of license to operate the EGE 106, permanent closure, tax implications etc.

In one implementation, for the purpose of imposing monitory fines on the EGEs 106, the EDCM system 104 may communicate with a financial system 120. The financial system 120 may be, in one example, a server of a bank or any other financial institution with which the owners of the EGEs 106 may maintain an account. In various other examples, the financial system 120 may be maintained by a government authority, such as a tax deduction authority with which the owners of the EGEs 106 are typically registered or a pollution control board with which each of the owners of the EGEs 106 may be required to be registered. In an implementation, the communication between the EDCM system 104 and the financial system 120 may be via diameter or XML (Extensible Mark-up Language) interfaces, as described later in the description. It will be appreciated that the financial system 120 may be configured to deduct appropriate applicable amount from the owners of the EGEs 106 towards payments of any monitory fines that may have been imposed on them and intimate the EGE owner. For example, the fined amount may be deducted from a bank account registered in the name of an EGE 106.

In one implementation, the EDCM system 104 may communicate with telecommunication network entities, such as a SCP (Service Control Point) of a service provider with which the EGE owner maintains an account, to deduct the fined amount from the mobile account (prepaid/postpaid) registered in the name of the EGE owner. Further, in one implementation, the fined amount may be incurred from the EGE owner through a manual means in which a memo of the fined amount may be sent to the EGE owner. As understood, the fined amount is in accordance with the severity levels of emission generated by an EGE 106 and the emission limits prescribed to the class and/or sub-class of EGEs corresponding to the EGE 106. The emission limits may be predefined by the emission regulatory authorities, or any relevant authority. The data relating to emission limits predefined by the emission regulatory authorities may be available with the financial system 120 or in accordance with one implementation explained previously, may reside in the data repository 116 which may be coupled to the financial system 120.

In an implementation, the EGE identification data and the emission data associated with a large number of EGEs 106 may be communicated by the EDCM system 104 to any entity, such as a statistics and report generation system 122 of an emission regulatory authority, for the purpose of generating statistics and/or reports on the emissions from the EGEs 106. The statistics may be generated for determining overall emissions from a territory or country at a global level, estimate emission trends over a period, build correlation between emission levels and the class and sub-class of the EGEs 106 to identify most polluting EGEs, etc. This may also assist a country in compiling emission data at national level for participating in carbon credit trading.

In an implementation, the EGE identification data and the emission data associated with a large number of EGEs 106 may be communicated by the EDCM system 104 to an entity configured with a carbon credit computation system 124 for assigning carbon credits to each EGE 106, which may enable the EGE owners for the purpose of carbon trading. The carbon credit computation system 124 may compute the carbon credits to be assigned to the EGE owners based on the emissions generated by the EGEs they own. Also, with this, a central database having carbon credits of all the EGEs 106 may be maintained, which may facilitate government authorities to efficiently keeping track of carbon credits and also carbon trading done by the EGE owners.

Further, in an implementation, the EGE identification data and the emission data associated with one or more EGEs 106 may be communicated to other entities and advantageously used for any other purpose and/or application in relation with the EGEs 106 and the environmental pollution caused by the EGEs 106.

For example, in an implementation, the EGE identification data associated with motor vehicles as the EGEs 106 may be communicated by the EDCM system 104 to an entity, having a vehicle tracking system (not shown in the figure), for the purpose of tracking and monitoring movements of motor vehicles. For such purpose, the EDCM system 104, apart from communicating the EGE identification data to the tracking system, in an implementation, may also communicate location details of the telecommunication network entity from which the encoded message is received. In another example, the EGE identification data associated with motor vehicles as the EGEs 106 may be utilized to evaluate vehicle performance, which can further be utilized for various purposes.

In an implementation, the notification system 118, the statistics and report generating system 122 and the carbon credit computation system 124 may be configured within the EDCM system 104, and the functionalities of such systems, as mentioned above, may be performed by the EDCM system 104.

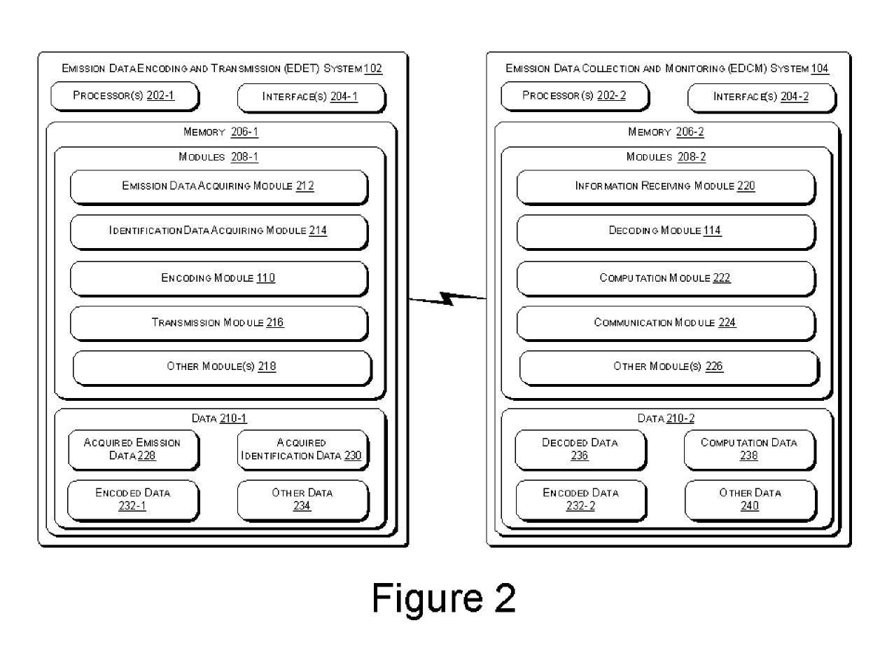

FIG. 2 illustrates the EDET system 102 and the EDCM system 104 according to an embodiment of the present subject matter. In accordance with the afore going description, the EDET system 102 and the EDCM system 104 are communicatively coupled to each other for the purposes of reporting and monitoring of emissions from the EGEs 106 via a telecommunication network.

The communication may be based on the GSM protocol, and in such a case the encoded message is the GLU message. Although the communication described herein is with reference to GSM network and the encoded message is the GLU message, the systems and methods of the present subject matter may be implemented in other networks and devices and the encoded messages may be in other forms of telecommunication-based encoded massages, albeit with a few variations, as will be understood by a person skilled in the art. Further, for the sake simplicity, FIG. 2 shows one EDET system 102 communicating with one EDCM system 104. However, in various implementations, a plurality of EDET systems 102 that obtain the emission data and the EGE identification data of EGEs may communicate with one or more of EDCM systems 104. Further, in similar manner, one EDET system 102 may obtain emission data and EGE identification data associated with more than one EGE.

In one implementation, the EDET system 102 may be implemented in a user equipment (UE) that includes, but is not limited to, a mobile phone, a smart phone, a PDA, and a handheld device, where the emission data and the EGE identification data may be encoded in the form of a telecommunication-based encoded message, such as the GLU message, and the GLU message is communicated by the UE to the telecommunication network entity, which further communicates the GLU message to the EDCM system 104.

Further, the EDET system 102 obtains the emission data from one or more ERDs 108. In an implementation, the ERD 108 may be an entity, coupled to the EGE 106 for the purpose of determining the emissions from the EGE 106. However, in another implementation, the EDET system 102 and the ERD 108 may be integrated to form a single entity configured to detect emissions from the EGE 106 as emission data, encode at least the emission data in the form of the GLU message and transmit the GLU message to the telecommunication network entity, which further communicates the GLU message to the EDCM system 104. This single entity, having the ERD 108 and the EDET system 102, may be coupled with the EGE 106 to detect emissions and communicate the GLU message with the emission data in real-time or periodically.

Although various embodiments of the EDET system 102 as well as the EDCM system 104 are possible, the same have been explained with respect to embodiments depicted in FIG. 2.

The EDET system 102 and the EDCM system 104 include processors 202-1, 202-2, collectively referred to as processor 202. The processor 202 may be implemented as one or more microprocessors, microcomputers, microcontrollers, digital signal processors, central processing units, state machines, logic circuitries, and/or any devices that manipulate signals based on operational instructions. Among other capabilities, the processor(s) is configured to fetch and execute computer-readable instructions stored in the memory.

The functions of the various elements shown in the figure, including any functional blocks labeled as “processor(s)”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), non-volatile storage. Other hardware, conventional and/or custom, may also be included.

Also, the EDET system 102 and the EDCM system 104 include interface(s) 204-1, 204-2, collectively referred to as interfaces 204. The interfaces 204 may include a variety of software and hardware interfaces that allow the EDET system 102 and the EDCM system 104 to interact with each other. Further, the interfaces 204 may enable the EDET system 102 and the EDCM system 104 to communicate with other communication and computing devices, such as web servers and external repositories. The interfaces 204 may facilitate multiple communications within a wide variety of networks and protocol types, including wire networks, for example LAN, cable, etc., and wireless networks, for example WLAN, cellular, satellite-based network, etc.

The EDET system 102 and the EDCM system 104 include memory 206-1, 206-2, collectively referred to as memory 206, coupled to the processors 202-1, 202-2. The memory 206 may include any computer-readable medium known in the art including, for example, volatile memory (e.g., RAM), and/or non-volatile memory (e.g., EPROM, flash memory, etc.).

The memory 206-1, 206-2 of the EDET system 102 and the EDCM system 104, respectively, includes modules 208-1, 208-2 and data 210-1, 210-2, collectively referred to as modules 208 and data 210, respectively. The modules 208 include routines, programs, objects, components, data structures, and the like, which perform particular tasks or implement particular abstract data types. The modules 208 further include modules that supplement applications on the EDET system 102 and the EDCM system 104, for example, modules of an operating system. The data 210 serves, amongst other things, as a repository for storing data that may be fetched, processed, received, or generated by one or more of the modules 208.

In an implementation, the modules 208-1 of the EDET system 102 includes an emission data acquiring module 212, an identification data acquiring module 214, a transmission module 216 and other module(s) 218 in addition to the encoding module 110. In an implementation, the data 210-1 of the EDET system 102 includes acquired emission data 228, acquired identification data 230, encoded data 232-1 and other data 234. The other module(s) 218 may include programs or coded instructions that supplement applications and functions, for example, programs in the operating system of the EDET system 102, and the other data 234 comprise data corresponding to one or more other module(s) 218.

Similarly, in an implementation, the modules 208-2 of the EDCM system 104 includes an information receiving module 220, a computation module 222, a communication module 224 and other module(s) 226 in addition to the decoding module 114. In an implementation, the data 210-2 of the EDCM system 104 includes encoded data 232-2, decoded data 236, computation data 238 and other data 240. The other module(s) 226 may include programs or coded instructions that supplement applications and functions, for example, programs in the operating system of the EDCM system 104, and the other data 240 comprise data corresponding to one or more other module(s) 226.

In an implementation, the emission data acquiring module 212 of the EDET system 102 acquires the emission data associated with at least one EGE 106. The emission data acquiring module 212 acquires the emission data from the ERD 108 coupled to the EGE 106. The emission data may be acquired in a digital format from the ERD 108. In an implementation, the emission data may be read from the ERD 108 and manually entered in the EDET system 102 through a user interface of the EDET system 102. The emission data, for example, may include the amounts of SPM and various harmful gases, such as CO, CO₂, NOx, SOx and other harmful hydrocarbons, generated by the EGE 106. In an implementation, where the EGE 106 is a motor vehicle, the emission data acquiring module 212 may be configured to acquire additional data, such as vehicle performance or technical parameters like engine RPM, number of cylinders and engine temperature, as a part of the emission data from the ERD 108 or by means such as employing relevant sensors. In the implementation, where the ERD 108 is coupled to the motor vehicle (the EGE 106) for continuous detection of emissions, the vehicle performance parameters including average vehicle speed, average engine RPM, average fuel consumption, average engine temperature over the duration of detection of emissions may also be stored in the ERD 108, which are acquired by the emission data acquiring module 212. The emission data along with the vehicle performance parameters, if any, are stored in the acquired emission data 228.

In an implementation, the EDET system 102 may acquire the EGE identification data associated with the EGEs 106 for which the emission data are obtained. The identification data acquiring module 214 of the EDET system 102 is configured to acquire the EGE identification data. In an implementation, the EGE identification data may be acquired from the ERDs 108 coupled to the EGEs 106, or may be manually entered in the EDET system 102 through a user interface of the EDET system 102. The EGE identification data may include the registration number of the EGE 106s, which is unique for each EGE 106, and the place of registration of the EGE 106. The EGE identification data may also include additional data related to class of the EGEs 106 and the corresponding pollution norm compliance level. The additional data related to class of the EGEs 106 may be indicative of the type of EGE, for example motor vehicle, factory or power producing plant; and sub-class of EGE, for example light, medium or heavy vehicle or factory. In an implementation, the EGE identification data may further include data related to the owners of the EGEs 106, for example name, address and contact number of the owners. The EGE identification data along with the additional data are stored in the acquired identification data 230.

Upon acquiring the emission data and the EGE identification data along with the additional data, the encoding module 110 of the EDET system 102 encodes the acquired data in the form of the GLU message that can be transmitted over a GSM network. The GLU message is stored in the encoded data 232-1. The encoding of the emission data, the EGE identification data and the additional data in the form of the GLU message is elaborated later in the description.

The GLU message encoded with the emission data and the EGE identification data is then transmitted by the transmission module 216 of the EDET system 102 to the EDCM system 104 through the GSM network. This transmission of the GLU message may take place in a manner in which a conventional location update message is transmitted to a telecommunication network entity using radio interfaces over a GSM network.

In an implementation, at the EDCM system 104, the information receiving module 220 receives the GLU message that is transmitted from the EDET system 102. The GLU message is stored in the encoded data 232-2. Upon receiving the GLU message, the decoding module 114 processes the GLU message to decode the emission data and the EGE identification data along with the additional data encoded in the GLU message. In an implementation, the GLU message may be processed to obtain the data such as class, sub-class, registration number and/or location of registration of the EGE 106 provided as the EGE identification data, and the levels of various harmful substances, including SPM and gases emitted by the EGE 106, encoded in the GLU message. In an implementation, the GLU message may also comprise data such as details of the owner of the EGE 106 and the vehicle performance parameters as mentioned earlier, and the same may also be obtained. The data obtained after processing of the GLU message is stored in the decoded data 236. In an implementation, the data obtained after processing of the GLU message may be stored in an external data repository associated with the EDCM system 104.

In an implementation, subsequent to obtaining the emission data and the EGE identification data along with the additional data associated with the EGE 106, the computation module 222 computes the severity level of emission for the EGE 106 by comparing the levels of emissions for each EGE 106 with the corresponding prescribed emission limits for the ECE class. For the purpose of comparison, the computation module 222 may communicate with the data repository 116, as mentioned earlier, which stores data related to the prescribed emission limits according to the ECE class and other relevant parameters. The data repository 116 may also store severity levels of emissions, for example from 1 to 10, for each class and sub-class of EGE 106, depending on the difference between current emission levels and the corresponding prescribed emission limits. In an implementation, also described earlier, the data repository may be integrated with the EDCM system 104, for example, as a part of the data 210-2 of the EDCM system 104.

The data repository 116 may also comprise data related to all the EGEs 106 including their class, for example motor vehicle, factory or power producing plant; sub-class, for example light, medium or heavy vehicle or factory; and unique registration number. The data repository 116 may also comprise EGE owner registration and subscription data and EGEs' make and manufacturing details. The data repository 116 may further comprise data related to owners of the EGEs 106 including owner details such as name, address, contact number, email details, bank account details and tax related details. The owner details may also include emission records history of their EGEs and/or default or allocated carbon credits for their EGEs. For the purpose of storing data in the data repository 116, the owners, for example, may have to register themselves and their EGEs with the EDCM system 104, and the registration may be done at the time of purchase or installation of the EGE 106. In an implementation, data stored in the data repository 116 may be updated periodically or as needed.

In an implementation, the computation module 222 is configured to compare the levels of emissions, obtained from the emission data in the GLU message, for each EGE 106 with the prescribed emission limits corresponding to the class, sub-class and pollution norm compliance of the EGE 106 as identified from the EGE identification data. Table 1 illustrates an example of a reference table with prescribed emission levels for motor vehicles, as the EGEs 106, which may be used for the purpose of comparison. Table 1 lists prescribed emission limits for Hydrocarbons, CO and NOx in ppm (parts per million) for various sub-classes of motor vehicles based on their year of manufacturing. The emission limits may vary for different jurisdictions. Other tables, similar to Table 1, may be used for the comparison. For example, reference tables with emission standards published by environmental pollution agencies may be used. Based on the comparison, the computation module 222 may compute the severity level of emissions for each EGE 106. The comparison results and the severity levels of emissions of each EGE 106 may be stored in the computation data 238, data repository 116 and/or an external repository associated with the EDCM system 104.

In an implementation, the computation module 222 may further match the class, the sub-class and the registration number of the EGE 106, obtained from the EGE identification data in the GLU message, for each EGE 106, with the data in the data repository 116 to fetch the corresponding owner details including the emission records history and/or the allocated carbon credits. The computation module 222, for the purpose of comparison and computing the severity level of emission for each EGE 106, may consider the emissions records history, and/or the allocated carbon credits, associated with the corresponding EGE 106.

TABLE 1

| | | | |
|---|---|---|---|
| Year of | | | |
| Manufacturing | Hydrocarbons (ppm) | CO (ppm) | NOx (ppm) |

Sub-class of vehicle: LIGHT WEIGHT VEHICLE

| | | | |
|---|---|---|---|
| >2000 | 1 | 1 | 2 |
| 1995-1999 | 2 | 10 | 15 |
| 1990-1994 | 2 | 15 | 25 |
| 1985-1989 | 4 | 20 | 35 |
| 1980-1984 | 4 | 25 | 40 |
| <1979 | 8 | 35 | 50 |

Sub-class of vehicle: MEDIUM WEIGHT VEHICLE

| | | | |
|---|---|---|---|
| >2000 | 1 | 4 | 5 |
| 1995-1999 | 3 | 12 | 20 |
| 1990-1994 | 4 | 18 | 30 |
| 1985-1989 | 5 | 24 | 40 |
| 1980-1984 | 8 | 28 | 50 |
| <1979 | 12 | 40 | 60 |

Sub-class of vehicle: HEAVY WEIGHT VEHICLE

| | | | |
|---|---|---|---|
| >2000 | 2 | 8 | 10 |
| 1995-1999 | 5 | 14 | 25 |
| 1990-1994 | 7 | 20 | 35 |
| 1985-1989 | 10 | 28 | 45 |
| 1980-1984 | 12 | 34 | 55 |
| <1979 | 15 | 48 | 65 |

In an implementation, based on the comparison of emissions and the severity levels of emissions of the EGEs 106, the communication module 224 of the EDCM system 104 may communicate with one or more entities, such as the previously described notification system 118, financial system 120, statistics and report generating system 122, and/or carbon credit computation system 124, for the purpose of sending a notification to the EGE owner, penalizing the EGE 106 or the EGE owner, generating statistics and reports on emissions, and facilitating tracking and trading of carbon credits for EGEs 106, respectively. For such purposes, the communication module 224 may communicate the emission data and/or the EGE identification data, associated with the EGEs 106, obtained from the GLU message, severity levels of emission for the EGEs 106, as generated by the computation module 222, and/or the additional data related to the EGEs 106 and the EGE owners as stored in the data repository 116 to the one or more entities.

The description below describes the encoding of the emission data and the EGE identification data in the form of the GLU message by the encoding module 110 of the EDET system 102, according to an implementation of the present subject matter. The encoding module 110 may also encode the additional data obtained by the EDET system 102.

TABLE 2

| Information Elements of GLU message | Length | |
|---|---|---|
| Mobility Management Protocol Discriminator | ½ | octet |
| Skip Indicator | ½ | octet |
| Location Updating | 1 | octet |
| Location Updating Type | ½ | octet |
| Ciphering Key Sequence Number | ½ | octet |
| Location Area Identification | 6 | octets |
| Mobile Station Classmark | 1 | octet |
| Mobile Identity | 2-9 | octets |

As mentioned previously, the GLU message is a GSM protocol based location update message transmitted by a communication device, such as a telecommunication device, to a telecommunication network entity, such as a VMSC, to indicate a current location of the communication device to the telecommunication network entity. The GLU message includes predefined information elements in accordance with GSM standards as will be known to one skilled in the art. Each information element in the GLU message is of a predefined length and encoded in binary format. The length of each information element is defined in terms of octets, where one octet is composed of eight bits. Table 2 lists the predefined information elements with their lengths for a typical GLU message according to the GSM standards.

In an implementation, the encoding module 110 encodes one of the information elements in the GLU message to indicate to the telecommunication network entity that the GLU message includes the emission data and the EGE identification data, and is different from the typical GSM location update message used for the telecommunication purposes. The encoding module 110 also encodes the emission data and the EGE identification data along with the additional data in the EDET system 102 in one or more of the above mentioned information elements to generate the GLU message according to the present subject matter. Each information element is explained below in context of the conventional GLU message and in context of the GLU message according to the present subject matter. Also, for purposes of the description below, the EDET system 102 may be considered to be implemented in a handheld communication device, such as a mobile phone, a smart phone, a PDA or the like in an example. Further, for the ease of explanation, the handheld communication device may be considered to be operating in two modes namely, a first mode—for conventional telecommunication purposes, and a second mode—for communicating the emission data and the EGE identification data in accordance with the present subject matter. a) Mobility Management Protocol Discriminator (MMPD): This information element defines the protocol of the GLU message. The MMPD is defined by ½ octet (4 bits) which forms first four bits of the first octet in the GLU message. Conventionally, the MMPD is set to 3 (0011) for call related message, set to 5 (0101) for mobility management message, set to 6 (0110) for radio resource management message, etc. In the first mode, the MMPD is set in a conventional manner based on the type of the message. In the second mode, the MMPD is set to 5 (0101) by the encoding module 110 to define the GLU message as the mobility management message.

b) Skip Indicator (SI): This information element is defined by ½ octet which forms last four bits of the first octet of GLU message. Conventionally, if the SI is not 0 (0000) the GLU message received at the telecommunication network entity is ignored. In an implementation, for the handheld communication device to operate in the second mode, the SI is set to 0 (0000) by the encoding module 110.

c) Location Updating (LU): This information element indicates whether the GLU message is a location update message and is defined by 1 octet. In the first mode and in the second mode of operation of the handheld communication device, the LU is set to 8 (00001000) to indicate the GLU message is a location update message.

d) Location Updating Type (LUT): This information element in the conventional GLU message indicates for a normal update, periodic update or an update attached with an IMSI (International Mobile Subscriber Identity) code. A part of the LUT also includes a Follow-on-Request (FOR) which indicates receipt of a follow-on request from the handheld communication device.

TABLE 3

| | | | | |
|---|---|---|---|---|
| Bits | 4 | 3 | 2 | 1 |

| | | | |
|---|---|---|---|
| ½ octet | FOR | Spare | Type of Update |

Table 3 illustrates details of the LUT of the GLU message, according to an implementation of the present subject matter. The LUT is defined by ½ octet. The first two bits of the LUT indicate the type of update. The third bit of the LUT is a spare bit, and the fourth bit of the LUT is the FOR bit. Conventionally, the first two bits are set to 0 (00) to define the normal update, set to 1 (01) to define the periodic update and set to 2 (10) to define the update attached with the IMSI code. The value of these two bits as 3 (11) is conventionally not in use and kept as reserved. The EDET system 102 exploits this reserved value of the two bits. Thus, the first two bits of the LUT set to 3 (11) may be used to indicate that the GLU message is the update message with the emission and the EGE 106 related data, instead of a typical telecommunication related data. Accordingly, in the second mode of operation of the handheld communication device, the encoding module 110 sets the first two bits of the LUT to 3 (11). The third and the fourth bits of the LUT may be set in a conventional manner in the first mode and in the second mode of operation.

e) Ciphering Key Sequence Number (CKSN): CKSN in the conventional GLU message enables the telecommunication network entity to identify the ciphering key stored in the handheld communication device without invoking an authentication procedure. The CKSN is allocated by the network entity and sent with the authentication request message to the handheld communication device where it is stored along with the ciphering key. The CKSN is defined by ½ octet which forms first four bits of an octet in the GLU message. The other four bits of this octet are used for other purposes. The first three bits of the CKSN indicate the ciphering key. Conventionally, the values of these three bits from 0 (000) to 6 (110) define the possible values of the ciphering key, and these three bits are set to 7 (111) to define no key available. In the second mode of operation, the first three bits of the CKSN are set to 7 (111) by the encoding module 110. The fourth bit of the CKSN is a spare bit and set to 0 (0) in the first and second modes operation.

f) Location Area Identification (LAI): This information element in the conventional GLU message provides for identification of location areas or the cells, within the area covered by the GSM network, in which the handheld communication device is present. Conventionally, the LAI is defined through 6 octets in the GLU message. However, in an implementation, in the second mode of operation, the LAI may be defined through a predefined number of octets, for example 1 to 5 (or any integer), and the encoding module 110 may encode at least the emission data of the EGE 106 in the LAI. In an implementation, the encoding module 110 may also encode, in the LAI, the additional details, such as the vehicle performance parameters, as obtained by the EDET system 102.

TABLE 4

| | | | | | | | | |
|---|---|---|---|---|---|---|---|---|
| Bits | 8 | 7 | 6 | 5 | 4 | 3 | 2 | 1 |

| | | |
|---|---|---|
| octet 1 | Level of CO emission | Level of CO₂ emission |
| octet 2 | Level of NOx emission | Level of SOx emission |
| octet 3 | Level of SPM emission | Level of other |
| | | Hydrocarbon emission |

| | |
|---|---|
| octet 4 | Levels of other harmful gaseous emissions |
| octet 5 | Additional data (Vehicle Performance or Technical |
| | Parameters (such as number of cylinders, engine |
| | RPM, engine temperature, average vehicle speed, |
| | average fuel consumption, etc.) |

Table 4 illustrates details of the LAI of the GLU message, according to an implementation of the present subject matter, as encoded by the encoding module 110. The LAI may be defined by 5 octets which are encoded with the emission data and the additional data. For example, the first four octets (octets 1 to 4) may be assigned to encode the levels of emissions, and the remaining octet (octet 5) may be assigned to encode the additional data including the vehicle performance or technical parameters as mentioned in Table 4. Further, one octet may be split to encode emissions related to two different pollutants. For example, as shown in Table 4, octets 1, 2 and 3 are split to encode the levels of CO—CO₂, levels of NOx-SOx emissions and levels of SPM-other hydrocarbon emissions, respectively.

In an implementation, the emission data acquiring module 212 may acquire the emission data and the additional data in their absolute values or in a format that defines the absolute values in terms of predefined levels, for example 1 to 10. For example, for CO emissions: level 1=0−10 ppm; level 2=10−20 ppm; and so on. These absolute values or the predefined levels are encoded in the pre-assigned octets, as mentioned in Table 4. In an implementation, the decoding module 114 of the EDCM system 104, after receiving the GLU message of the present subject matter, processes the GLU message to decode the absolute values or the predefined levels of emissions and the additional data from the LAI.

g) Mobile Station Classmark (MSCM): MSCM in the conventional GLU message provides the telecommunication network entity with information related to high priority aspects of the handheld communication device. This information element indicates characteristics of handheld communication device and is defined by 1 octet in the GLU message. Conventionally, the value of MSCM depends on the telecommunication network entity which provides the telecommunication services. Thus, in an implementation, the MSCM in the second mode of operation may be retained in the same form by the encoding module 110 as that in the first mode.

h) Mobile Identity (MI): The MI in the conventional GLU message provides for information on IMSI (International Mobile Subscriber Identity), TMSI (Temporary Mobile Subscriber Identity), IMEI (International Mobile Equipment Identification) and/or IMEISV (IMEI with software version number). Conventionally, the MI is defined through 3 to 10 octets in the GLU message. However, in an implementation, in the second mode of operation of the handheld communication device, the MI may be defined through a predefined number of octets, for example 1 to 10 (or any integer), and the encoding module 110 may encode at least the EGE identification data of the EGE 106 in the MI. In an implementation, the encoding module 110 may also encode, in the MI, the additional data related to the owners of the EGEs 106 as obtained by the EDET system 102.

TABLE 5

| | | | | | | | | |
|---|---|---|---|---|---|---|---|---|
| Bits | 8 | 7 | 6 | 5 | 4 | 3 | 2 | 1 |

| | | |
|---|---|---|
| octet 1 | Class of EGE | Sub-class of EGE |

| | |
|---|---|
| octet 2 | Registration number/Location and place of |
| octet 3 | registration of EGE |
| octet 4 | |
| octet 5 | |
| octet 6 | |
| octet 7 | Additional data related to EGE and owner of the |
| octet 8 | EGE (owner's name, contact details, emission detail |
| octet 9 | history, pollution norm compliance etc.) |
| octet 10 | |

Table 5 illustrates details of the MI of the GLU message, according to an implementation of the present subject matter, as encoded by the encoding module 110. The MI may be defined by 10 octets which are encoded with the EGE identification data and the owner details. For example, the first octet (octet 1) may be assigned to encode the class and the sub-class of one EGE 106, the next five octets (octets 2 to 6) may be assigned to encode the registration number of the EGE 106, and the remaining octets (octets 7 to 10) may encode the additional data related to the EGE 106 and the owner of the EGE 106 as mentioned in Table 5. The first octet may be split to encode the class and the sub-class of the EGE 106.

In an implementation, the identification data acquiring module 214 may acquire the EGE identification data and the owner details from the ERD 108. The obtained EGE identification data and owner details are encoded in the pre-assigned octets, as mentioned in Table 5. In an implementation, the decoding module 114 of the EDCM system 104, after receiving the GLU message of the present subject matter, processes the GLU message to decode the EGE identification data and the owner details from the MI.

In an implementation, the information elements in the GLU message of the present subject matter may be encoded in various conventionally known ways. Further, in an implementation, the numbers of octets that define the LAI and the MI, and the assignment of octets to encode the emission data and the EGE identification data along with the additional data may be defined depending on the requirements.

In an implementation, the GLU message, encoded in the handheld communication device in the manner described above, is transmitted to the VMSC via BTS/BSC. The VMSC further communicates with the VLR to further communicate information to the EDCM system 104. At the VMSC and the VLR, mapping of the information elements of the GLU message takes place, as illustrated in Table 6. At the VMSC, the LUT, CKSN, LAI and MI information elements of the GLU message transmitted from the EDET system 102 are mapped on to corresponding LUT, CKSN, target LAI and IMSI information elements, respectively, which are communicated to the VLR. At the VLR, the LUT is checked to identify whether the GLU message from the EDET system 102 includes the emission and EGE related data. Upon identifying that the GLU message includes the emission and the EGE related data, the target LAI is mapped on to Supported Camel Phases and Extension Containers and the IMSI is mapped on to the corresponding IMSI, which are communicated to the EDCM system 104.

TABLE 6

| GLU message | MAP Location Area | MAP Location Update |
|---|---|---|
| (EDET system | Update (LUA) Request | (LU) Request (VLR to |
| 102 to VMSC) | (VMSC to VLR) | EDCM system 104) |
| LUT | LUT → LUT | — |
| (with first two | | |
| bits set to 3) | | |
| CKSN | CKSN → CKSN | — |
| (set to 7) | | |
| LAI | LAI → Target LAI | Target LAI → |
| (with emission | | Supported Camel |
| data and the | | Phases and |
| additional data) | | Extension Containers |
| MI | MI → MSI | IMSI → IMSI |
| (with EGE | | |
| identification | | |
| data and the | | |
| additional data) | | |

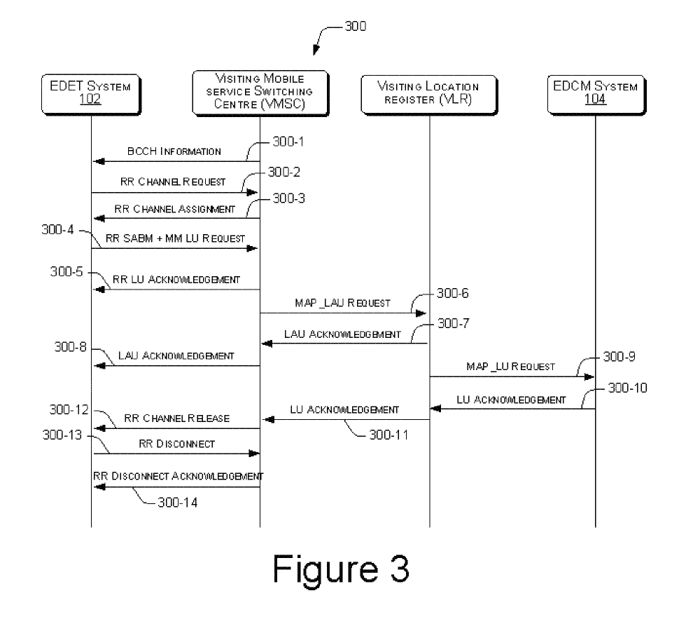

FIG. 3 illustrates a call flow diagram 300 for communication between the EDET system 102 and the EDCM system 104 in the GSM network, according to an embodiment of the present subject matter. Various arrow indicators used in the call flow diagram 300 depict transfer of data between the EDET system 102, the VMSC, the VLR and the EDCM system 104. Although the description of FIG. 3 is with respect to the GSM network, it will be understood that the communication may take place via other telecommunication networks as well.

In the call flow diagram 300, at step 300-1, the EDET system 102 communicates with the VMSC to acquire information on signal strength of the Broadcast Control Channel (BCCH) to select a cell in a cluster of the GSM network. After selecting the cell, the EDET system 102, at step 300-2, sends a Radio Resource (RR) channel request to establish a radio communication link with the VMSC for sending the GLU message. Upon receiving such a request from the EDET system 102, the VMSC assigns the RR channel to the EDET system 102, at step 300-3. Once the radio communication link is established, the EDET system 102 sends an RR Set Asynchronous Balance Mode (SABM) message along with the location update (LU) request to the VMSC, at step 300-4. In the LU request, the GLU message, as encoded by the EDET system 102 of the present subject matter, is also sent to the VMSC. To confirm the receipt of the SABM and GLU message, the VMSC sends an LU acknowledgement message to the EDET system 102, at step 300-5.

After receiving the GLU message, the VMSC sends a mapped location area update (MAP LAU) request to the VLR, at step 300-6. In this request, the LUT, the CKSN, the LAI and the MI information elements of the GLU message are mapped, as shown in Table 6, and sent to the VLR. The VLR sends an LAU acknowledgement back to the VMSC, at step 300-7, to confirm the receipt of the mapped information elements. Subsequently, an LAU acknowledgement is sent by the VMSC to the EDET system 102, at step 300-8.

After receiving the mapped information elements, the VLR check the value of LUT. If the value of LUT is found to be 3, as set by the EDET system 102 to communicate the emission and EGE related data, the VLR sends a mapped LU request to the EDCM system 104, at step 300-9. In this request, the target LAI (mapped with LAI) and the IMSI (mapped with MI) information elements at the VLR are mapped, as shown in Table 6, and sent to the EDCM system 104. The EDCM system 104, upon receiving the mapped information elements, sends an LU acknowledgement to the VLR, at step 300-10, and the VLR subsequently sends an LU acknowledgement to the VMSC, at step 300-11. The EDCM system 104, after receiving the mapped information elements, processes the information element to obtain the emission data, the EGE identification data, and/or the additional data encoded therein. At step 300-12, the VMSC sends a RR channel release message to the EDET system 102 to release the radio communication link between the two, and after receiving such a message, the EDET system 102, at step 300-13, sends a RR disconnect message to the VMSC. The VMSC disconnects the radio communication link between the EDET system 102 and the VMSC and, at step 300-14, the VMSC sends a RR disconnect acknowledge message to the EDET system 102.

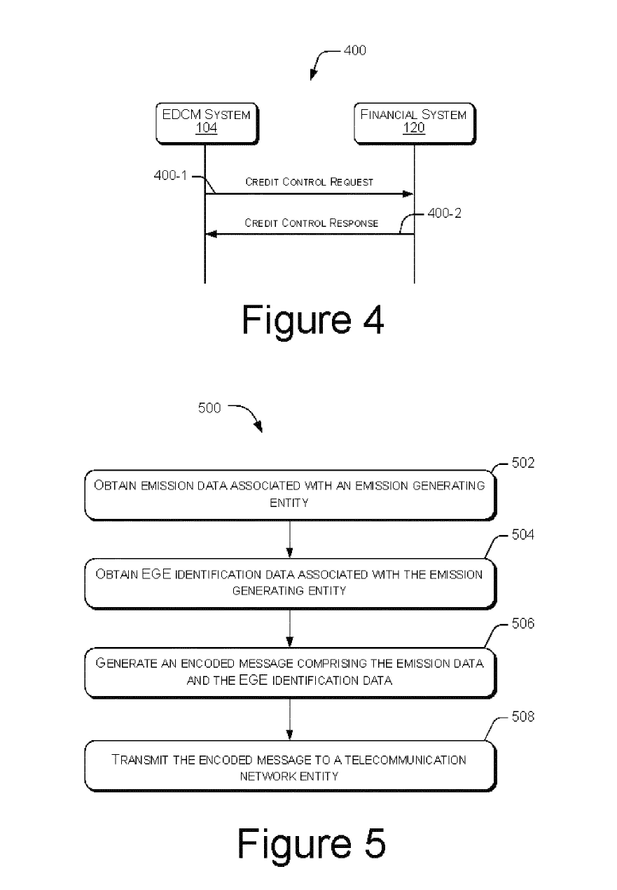

FIG. 4 illustrates a message flow diagram 400 for communication between the EDCM system 104 and the financial system 120 through XML interfaces, according to an embodiment of the present subject matter, for the purpose of imposing monetary penalty of the owner of the EGE 106 based on the severity level of emissions from his EGE as computed by the EDCM system 104. In an implementation, the financial system 120 may be a banking entity or a banking gateway. Although the description of FIG. 4 is with respect to communication through XML interfaces, it will be understood that the communication may take place via Internet Protocol (IP) based interfaces as well.

TABLE 7

| Attribute Value Pairs of Credit | |
|---|---|
| Control request message | Information |
| Credit Control Request Type | Event request from EDCM system 104 |
| Requested Action | Direct debiting |
| Service Identifier | To indicate to the owner of the EGE |
| | 106 the reason for deduction |
| Subscription Identifier Data | Bank account number and/or other |
| | details of the EGE owner |
| Request Service Unit | Penalty amount to be imposed |

In the message flow diagram 400, at step 400-1, the EDCM system 104 sends a credit control (CC) request message to the financial system 120 for the purpose of imposing monetary penalty on the EGE owner. The CCR message includes various attribute value pairs (AVPs). Some of the AVPs of the CC request message, according to an implementation, are illustrated in Table 7. Each of the AVPs may be of a predefined length and include data that conveys information as described in Table 7 to the financial system 120. For example, the Credit Control Request Type may convey that an event request is made by the EDCM system 104, the Request Action may convey that direct debiting of an account is to be done, the Service Identifier may convey to the EGE owner the reason of deduction of money from his account, the Subscription Identifier Data may convey the bank account number and/or other details of the EGE owner as stored with the data repository 116 and/or EDCM system 104, and the Request Service Unit may convey the penalty amount to be imposed and deducted from EGE owner's bank account. Upon receiving the CC request message, the financial system 120 may process the CC request message and, based on the data in the AVPs, may take penalty action to deduct the penalty amount.

TABLE 8

| Response Code | Information |
|---|---|
| 0 | Successful deduction |
| 1 | Unsuccessful due to insufficient balance |
| 2 | Unsuccessful due to account not found |
| 3 | Unsuccessful due to invalid account details |

The financial system 120, after taking the penalty action, sends a credit control (CC) response message to the EDCM system 104, at step 400-2, to indicate the outcome of the penalty action. The CC response message may include a response code that conveys whether the penalty action is successful or an error occurred while completing the penalty action. Table 8 illustrates the response codes and the information conveyed by them, according to an implementation. For example, the response code is 0 to communicate that the penalty amount is successfully deducted from the EGE owner's account, the response code is 1 to communicate that the penalty action was unsuccessful due to insufficient balance in the EGE owner's bank account, and so on. Based on the response code received in the CC response message from the financial system 120, the EDCM system 104 may take an action to communicate with the EGE owner about the penalty action.

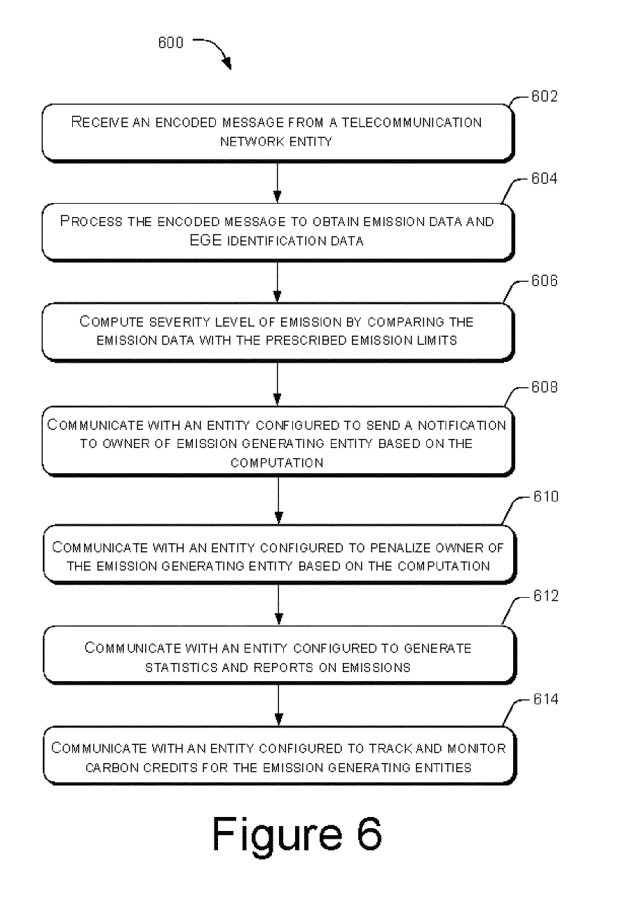

FIG. 5 illustrates a method 500 for encoding and transmitting of the emission data and the EGE identification data associated with an EGE 106, in accordance with an embodiment of the present subject matter, while FIG. 6 illustrates a method 600 for collecting and monitoring of the emission data and the EGE identification data associated with the EGEs 106, in accordance with an embodiment of the present subject matter.

The order in which the methods 500 and 600 are described is not intended to be construed as a limitation, and any number of the described method blocks can be combined in any order to implement the methods 500 and 600, or an alternative method. Additionally, individual blocks may be deleted from the method without departing from the spirit and scope of the subject matter described herein. Furthermore, the methods can be implemented in any suitable hardware, software, firmware, or combination thereof.

A person skilled in the art will readily recognize that steps of the method can be performed by programmed computers. Herein, some embodiments are also intended to cover program storage devices, for example, digital data storage media, which are machine or computer readable and encode machine-executable or computer-executable programs of instructions, wherein said instructions perform some or all of the steps of the described method. The program storage devices may be, for example, digital memories, magnetic storage media such as a magnetic disks and magnetic tapes, hard drives, or optically readable digital data storage media. The embodiments are also intended to cover both communication network and communication devices configured to perform said steps of the exemplary method.

Referring to FIG. 5, although the method 500 for encoding and transmitting of the emission data and the EGE identification data associated with an EGE 106 may be implemented in a variety of communication devices working in different network environments, in an embodiment described in FIG. 5, the method 500 is explained in context of the aforementioned EDET system 102 for the ease of explanation.

In an implementation, at block 502, the EDET system 102 obtains at least the emission data associated with an EGE 106. In an implementation, the EDET system 102 may obtain the emission data from an ERD 108 coupled to the EGE 106. The EDET system 102 may also obtain additional data such as vehicle performance or technical parameters of the EGE 106 as mentioned earlier, at block 502. At block 504, the EDET system 102 obtains at least the EGE identification data associated with the EGE 106, and the EDET system 102 may also obtain additional data such as details of the owner of the EGE 106, at block 504. In an implementation, the EDET system 102 may obtain the EGE identification data from the ERD 108 coupled to the EGE 106 or may be manually entered in the EDET system 102.

Upon obtaining the emission data and the EGE identification data along with the other relevant data, at block 506, the EDET system 102 generates an encoded message comprising the emission data and the EGE identification data. The encoded message may also comprise the additional data obtained at blocks 502 and 504. The encoded message is a telecommunication-based encoded message that can be transmitted over a telecommunication network, for example a GSM network.

In an implementation, the encoded message is a GLU message may be transmitted over the GSM network, for example by a communication device, such as a handheld communication device, a mobile phone, smart phone and a PDA, implementing the method 500. In said implementations, the emission data and the EGE identification data along with the additional data is encoded in predefined information elements of the GLU message, as described earlier.

After generating the encoded message, at block 508, the encoded message is transmitted to a telecommunication network entity. In accordance with the above example, where the encoded message is the GLU message, the telecommunication network entity may be a VMSC/VLR. At the telecommunication network entity, the encoded message, received from the EDET system 102, is checked to determine whether the encoded message includes the emission data and the EGE identification data associated with an EGE 106. Upon determining that the encoded message includes the emission data and the EGE identification data, the encoded message is transmitted to the EDCM system 104 for collection and monitoring of emissions.

FIG. 6 illustrates a method 600 for collecting and monitoring of the emission data and the EGE identification data associated with the EGEs 106, in accordance with an embodiment of the present subject matter. Although, the method 600 for collecting and monitoring of the emission data and the EGE identification data associated with an EGE 106 may be implemented in a variety of computing systems working in different network environments, in an embodiment described in FIG. 6, the method 600 is explained in context of the aforementioned EDCM system 104 for the ease of explanation.

In an implementation, at block 602, the EDCM system 104 receives the encoded message, comprising at least the emission data and the EGE identification data associated with an EGE 106, from the telecommunication network entity as transmitted by the EDET system 102. The encoding message may include the additional data as mentioned earlier. Upon receiving the encoded message, at block 604, the EDCM system 104 processes the encoded message to decode the emission data and the EGE identification data along with other details present therein. The encoded message may be processed to obtain levels of emission of various gases, SPM and/or other harmful substances; class, sub-class, registration number and location of registration of the EGE 106, as encoded in the encoded message. The encoded message may be processed to obtain the vehicle performance or technical parameters and the owner details, as encoded in the encoded message.

In an implementation, at block 606, a severity level of emission for the EGE 106 is computed, may be, by comparing the levels of emissions of various gases, SPM and/or other harmful substance emitted by the EGE 106, as obtained from the encoded message, with the corresponding prescribed emission limits. Based on the computed severity level of emission of the EGE 106, the EDCM system 104 may be configured to communicate the emission data, the EGE identification data and/or the severity level of emission for at least one predefined process or take further actions as defined below.

For example, at block 608, the EDCM system 104 may communicate with an entity configured with the notification system 118 to send a notification on emissions, based on the computed severity level of emission, to the EGE 106 or the EGE owner. In an example, at block 610, the EDCM system 104 may communicate with an entity configured with the financial system 120 to impose a penalty, based on the computed severity level of emission, on the EGE owner. In another example, at block 612, the EDCM system 104 may communicate with an entity configured with the statistics and report generating system 122 to generate statistics and/or reports on the emissions generated by the EGEs 106. Further, in an example, at block 614, the EDCM system 104 may communicate with an entity configured with the carbon credit computing system 124 to compute carbon credits for the EGEs 106, based on the severity level of emission.

In another example, the EDCM system 104 may communicate the EGE identification data, in case the EGEs 106 are motor vehicles, to an entity configured with a vehicle tracking system for the purpose of tracking of vehicles. In other examples, the performance or technical parameters may be communicated to the EGE owner for scheduling EGE maintenance or upkeep. The technical parameters obtained may be used for profiling of EGE classes and may then be used for selling the information to surveying or marketing companies. In another example, the EGE identification data and the additional data related to the EGEs 106 at the EDCM system 104 may be used for EGE class profiling. For example, in the cases of motor vehicles as the EGEs 106, the data may be used to ascertain the performance of a class of vehicle in terms of mileage, etc. The performance related data may then be sold to marketing companies and other survey companies, or may be notified to the EGE users which may help them identify problems and schedule maintenance/service.

Although implementations for the ERM system 100 have been described in language specific to structural features and/or methods, it is to be understood that the appended claims are not necessarily limited to the specific features or methods described. Rather, the specific features and methods are disclosed as exemplary implementations for reporting and monitoring of emissions.

1. An emission data encoding and transmitting (EDET) system comprising:
a processor; and
a memory coupled to the processor, wherein the memory comprises:
an emission data acquiring module configured to obtain emission data, wherein the emission data is associated with at least one emission generating entity (EGE);
an encoding module configured to generate an encoded message comprising, at least in part, the emission data; and
a transmission module configured to transmit the encoded message to a telecommunication network entity.

2. The EDET system as claimed in claim 1, wherein the encoded message is a GSM (Global System for Mobile Communication) based Location Update (GLU) message, and wherein, in the GLU message, Location Update Type is configured to a value 3 and Location Area Identification is configured with the emission data.

3. The EDET system as claimed in claim 1, wherein the EDET system is a wireless communication device.

4. The EDET system as claimed in claim 1, wherein the EDET system is communicatively coupled to an emission reading device to obtain the emission data associated with the at least one EGE, and wherein the emission data comprises amounts of at least one of air-pollutants, water pollutants and soil-pollutants.

5. The EDET system as claimed in claim 1, wherein the emission data acquiring module comprises an emission reading device.

6. The EDET system as claimed in claims 1 further comprising an identification data acquiring module configured to obtain EGE identification data, wherein the EGE identification data is associated with the at least one EGE, and wherein the encoded message further comprises, at least in part, the EGE identification data.

7. The EDET system as claimed in claim 1, wherein the telecommunication network entity comprises one or more of a Base Station Controller (BSC), Base Transceiver Station (BTS), Mobile Switch Center (MSC), Visiting Location Register (VLR), Radio Network Controller (RNC), Node B.

8. An emission data collection and monitoring (EDCM) system comprising:
a processor; and
a memory coupled to the processor, wherein the memory comprises:
an information receiving module configured to receive an encoded message from a telecommunication network entity, wherein the encoded message comprises, at least in part, emission data and EGE identification data associated with at least one emission generating entity (EGE); and
a decoding module configured to process the encoded message to obtain the emission data and the EGE identification data.

9. The EDCM system as claimed in claim 8, wherein the encoded message is a GSM (Global System for Mobile Communication) based Location Update (GLU) message.

10. The EDCM system as claimed in claim 8 further comprising a computation module configured to compute a severity level of emissions for the at least one EGE by comparing the emission data associated with the at least one EGE with predefined emission limits.

11. The EDCM system as claimed in claim 8 further comprising a communication module configured to communicate with one or more of a notification system, a financial system, a statistics and report generating system, a carbon credit computing system, and a vehicle tracking system.

12. The EDCM system as claimed in claim 11, wherein the communication module communicates with the financial system through at least one of an Extensible Mark-up Language interfaces and Diameter interfaces.

13. A method comprising:
obtaining emission data associated with at least one emission generating entity (EGE);
obtaining EGE identification data associated with the at least one EGE;
generating an encoded message comprising, at least in part, the emission data and the EGE identification data; and
transmitting the encoded message to a telecommunication network entity.

14. The method as claimed in claim 13, wherein the encoded message is a GSM (Global System for Mobile Communication) based Location Update (GLU) message, and wherein Location Updating Type in the GLU message is configured.

15. The method as claimed in claim 13, wherein, in the GLU message, Location Area Identification is configured with the emission data and Mobile Identity is configured with the EGE identification data.

16. A method comprising:
receiving a GSM (Global System for Mobile Communication) based Location Update (GLU) message from a telecommunication network entity, wherein the GLU message comprises, at least in part, emission data and EGE identification data associated with at least one emission generating entity (EGE); and
processing the GLU message to obtain the emission data and the EGE identification data associated with the at least one EGE

17. The method as claimed in claim 16 further comprising one or more of
computing a severity level of emission by comparing the emission data with the predefined emission limits to impose a penalty action on an owner of the at least one EGE and send a notification to the owner of the at least one EGE;
communicating the emission data and the EGE identification data to an external server for generating statistics and reports on the emission data; and
communicating the emission data and the EGE identification data to an external server for computing and monitoring carbon credits for the at least one EGE.

18. A computer-readable medium having computer-executable instructions that when executed perform acts comprising:
obtaining emission data associated with at least one emission generating entity (EGE);
obtaining EGE identification data associated with the at least one EGE;
generating a GSM (Global System for Mobile Communication) based Location Update (GLU) message comprising, at least in part, the emission data and the EGE identification data; and
transmitting the GLU message to a telecommunication network entity.

19. A computer-readable medium having computer-executable instructions that when executed perform acts comprising:
receiving a GSM (Global System for Mobile Communication) based Location Update (GLU) message from a telecommunication network entity, wherein the GLU message comprises, at least in part, emission data and EGE identification data associated with at least one emission generating entity (EGE); and
processing the GLU message to obtain the emission data and the EGE identification data associated with the at least one EGE; and
communicate the emission data and the EGE identification data for at least one predefined process.
